(19) United States
(12) Patent Application Publication
(10) Pub. No.: US 2009/0145189 A1
(43) Pub. Date: Jun. 11, 2009

(54) Composition and a manufacturing method thereof

(76) Inventor: Nils Hjelte, Raa (SE)

Correspondence Address: HARNESS, DICKEY & PIERCE, P.L.C., P.O. BOX 8910, RESTON, VA, 20195, US

(21) Appl. No.: 12/213,422

(22) Filed: Jun. 19, 2008

(30) Foreign Application Priority Data
Dec. 7, 2007 (SE) SE-0702717-0

(51) Int. Cl. C09K 17/14

(52) U.S. Cl. 71/27

(57) ABSTRACT

The present invention discloses a method of producing an aqueous solution of partially deprotonated aminopolycarboxylic acid from a partially or fully deprotonated aminopolycarboxylic acid. Additionally it discloses such aqueous solutions and their use.

### FIELD OF THE INVENTION

The present invention relates to an aqueous solution, which comprises a partially protonated aminopolycarboxylic acid. Furthermore it relates to use of such a solution and to methods for producing such solutions.

### BACKGROUND

Chelating amino polycarboxylic acids, such as diethylenetriamine-N,N,N-penta-acetic acid (DTPA), ethylenedinitrilotetraacetic acid (EDTA), N,N-bis(carboxymethyl)glycine (NTA), imidodiacetic acid (IDA), N,N′-ethylenediaminediacetic acid (EDDA), 1,2-diaminocyclohexane-N,N,N′,N′-tetraacetic acid (CyDTA), triethylenetetraaminehexaacetic acid (TTHA), hydroxyethyliminodiacetic acid (HEIDA), N,N-di(2-hydroxyethyl)glycine (DHEG), glycine, N-(2-hydroxyethyl)ethylenediaminetriacetic acid (HEDTA), ethylenedimanine-N,N′-bis(2-hydroxyphenyl)acetic acid (EDDHA), ethylenedimamine-N,N′-bis(2-hydroxy-4-methylphenyl)acetic acid (EDDH4MA) and the like, may be used to chelate metal ions. Accordingly, they may be used to remove metal ions, such as calcium and magnesium, from different sources, such as wastewater.

Furthermore metal chelates of aminopolycarboxylic acids have proved to be a highly desirable form for administering chelatable metals in industrial, agricultural, medical and other applications where slow or controlled release is needed. Due to their solubility, these organometallic or metalorganic complexes have been useful for supplying metals under conditions where metal supplied by other means may be rendered insoluble or unavailable.

One important application of water-soluble metalorganic complexes is for supplying cationic trace elements essential for adequate plant growth, such as Fe, Mn, Zn, Cu, etc. These metalorganic complexes or chelates are usually supplied to soil or plant growth medium, with or without fertilizers. Such chelates include, but are not limited to, chelates of EDTA, DTPA and EDDHA. In certain areas, the soil is heavy and compact, rendering the application of trace mineral in soil impractical. In such situations, foliar application, i.e. an application wherein compositions containing metal chelates are sprayed on the plants, is frequently employed. Such operations have provided a suitable means for providing the necessary trace metals. However, such operations have been accompanied by undesirable side effects, such as burning or spotting of leaves. The undesirable side effects appear to be attributable to by-products, such as sodium chloride, present in metalorganic complex compositions obtained by currently employed production methods.

The penta sodium salt of diethylenetriamine-N,N,N-penta-acetic acid (DTPA-Na₅) may be produced in a carboxymethylation process from diethylenetriamine, formaldehyde, sodium cyanide and caustic. The resulting technical product will, in addition to DTPA-Na₅, also comprise NTA, tetrasodium diethylenetriamino-tetraacetate (DETATetA-Na₄) and trisodium ditethylenetriamino-triacetate (DETATriA-Na₃) as by-products. The two latter are strong chelating agents, while NTA is a somewhat weaker chelating agent. DETATetA-Na₄ and DETATriA-Na₃ are produced as a result of incomplete carboxymethylation of the diethylenetriamine, to keep the NTA content at a minimum.

Similarly, the tetrasodium salt of EDTA may be synthesized from 1,2-diaminoethane(ethylenediamine), formaldehyde(methanal), water and sodium cyanide. Technical tetrasodium salts of EDTA produced in this way will also comprise other chelating by-products, such as NTA, trisodium ethylenedinitrilotriacetic acid (EDTriANa3) and disodium ethylenedinitrilodiacetic acid (EDDiANa2).

Technical commercial DTPA-Na₅ produced in a carboxymethylation process usually comprises a NTA level corresponding to 5 to 10 wt % of the chelating species in the product and a level of DETATetA-Na₄ and DETATriA-Na₃ usually corresponding to 5 to 10 wt % of the chelating species in the product. Further, a commercial aqueous solution of about 40 wt % DTPA-Na₅, such as Versene 80 sold by Dow Chemicals, has a caustic content of about 0.5 to 1.0 wt %. Similarly, technical EDTA-Na₄ comprising about 75 wt % EDTA-Na₄ and about 5 wt % water, may also comprise other chelating by-products, such as 5 to 15 wt % EDTriANa₃ and EDDiANa₂ and 5 to 10 wt % NTA.

A solution of technical commercial DTPA-Na₅, will get very viscous at concentration about 50 wt % and higher. Consequently, such solutions are sold as solutions with a concentration of about 40 wt % of the chelating species.

The chelating value of a solution comprising a chelating agent may be determined via titration, with calcium in the presence of oxalate, or via potentiometric titration with ferric chloride. Such procedures are, for one example, described in “KEYS to Chelation” issued by Dow Chemical Company in 2000.

In the context of the present application, chelating value is given as determined by potentiometric titration with ferric chloride. Chelating value may also be referred to as active content and is a measurement of the share, i.e. percentage, of chelating species in a given sample. As the chelating value refers to the number of species, the chelating value may differ slightly from the mass percentage of a given species if the different cheating species have different molecular weights.

DTPA, in its protonated form, may be produced from DTPA-Na₅ via precipitation of DTPA in presence of a strong acid. The drawback of this process is the loss of chelating species, i.e. loss of DETATetA-Na₄, DETATriA-Na₃ and other chelating species, such as NTA, present as by-products in technical DTPANa₅. While DTPA precipitates, the other chelating species remain in solution. Further, the other chelating agents present in the mother liquor after precipitation of DTPA, may cause environmental problems when discharged. Production of EDTA from technical EDTA-Na₄ may also in a similar way result in a loss in chelating species.

Technical DTPANa₅ is used for the manufacture of aqueous DTPAFe(III)NaH by reaction with an equimolar amount of ferric chloride in water in the presence of hydrochloric acid, as it is important that the pH do not exceed 6.5. As technical DTPANa₅ is basic and contains caustic, it is necessary to add hydrochloric acid to bring the pH of the reaction solution down to about 6.5. The solution is diluted with water so that the final product solution has a chelated iron content of 3.0 to 3.5 wt %. Higher concentrations may result in precipitations on storage, due to the high sodium chloride content of about 14 wt %. The product solution is used successfully in the greenhouse industry by the drip irrigation system. In foliar applications, such as flower applications, the salt content, such as sodium chloride, may cause serious scorching of leaves.

Another liquid product comprising DTPA, which was originally developed for the photo industry, is nowadays also used in agriculture. It contains 6 wt % Fe(III) in form of DTPAFe(III)(NH₄)₂ and is made from DTPA. Accordingly, as technical DTPANa₅ is used as starting material in the production of DTPA, a loss of chelating species is seen when comparing the number of chelating species in DTPAFe(III)(NH₄)₂ with the number of chelating species in technical DTPANa₅. The production of such a product and a similar EDTA based product is described in GB 1,343,977. A further drawback of this method is the need to use ammonia to replace protons in the product. This extra step is costly and it would be desirably to eliminate the need for this extra step.

U.S. Pat. No. 4,212,994 discloses a process for preparing a water soluble aminopolycarboxylic acid from its corresponding alkali metal-type carboxylate, comprising the steps of: (1) reacting by contacting an aqueous solution of the metal or ammonium carboxylate with a liquid, preferably strong, cation exchange agent in a substantially water insoluble organic solvent which does not dissolve the corresponding aminopolycarboxylic acid; and (2) separating the aqueous solution containing the effected aminopolycarboxylic acid from the organic solvent. This process requires that the product is water soluble, as the exemplified HEDTA is. In contrast, DTPA has low water solubility, whereby the method disclosed in U.S. Pat. No. 4,212,994 not can be regarded as suitable to form DTPA from DTPANa₅. Further, the disclosed process comprises the use of environmental unfriendly organic solvents. In addition, the need for separation of the two phases is less suitable when applied in industrial scale.

U.S. Pat. No. 3,172,898 discloses that metal chelates of aminopolycarboxylic acid compounds may be prepared in a process which comprises: (1) contacting an aqueous solution of a water soluble salt of a chelatable metal with the salt form of a strongly acidic cation exchange resin, such as a sulfonic acid ion exchange resin, to exchange thereon a chelatable metal cation; (2) contacting said resin, bearing said chelatable metal, with an aminopolycarboxylic acid chelating agent to produce the desired metal chelate of said aminopolycarboxylic acid; and (3) recovering said metal chelate from the resin surface by washing or eluting with water. Iron is tightly bound to the strongly acidic cation exchange resin. Accordingly, for ion exchange to take place, harsh conditions, e.g. heating in steam bath, and long reactions times are needed.

### SUMMARY

Accordingly, embodiments of the present invention seeks to mitigate, alleviate, circumvent or eliminate one or more of the above-identified deficiencies and to provide an aqueous solution comprising a partially deprotonated aminopolycarboxylic acid and a method of producing such a solution. For this purpose the method comprises the steps of:

providing a solution of a partially or fully deprotonated aminopolycarboxylic acid;

bringing said solution of a partially or fully deprotonated aminopolycarboxylic acid in contact with a solid weak or moderately strong acidic cation exchanger in its protonated form; and

separating the solid cation-exchanger from the produced solution of a partially deprotonated aminopolycarboxylic acid, wherein the degree of protonation is higher than in the starting material.

Advantageous features of the invention are defined in the dependent claims.

### DETAILED DESCRIPTION OF EXAMPLE EMBODIMENTS

In one embodiment according to the invention, a partially or fully deprotonated aminopolycarboxylic acid, such as a sodium salt of a partially or fully deprotonated aminopolycarboxylic acid, is reacted with a solid protonated acidic cation-exchanger. As a result, partially protonated forms of the aminopolycarboxylic acid with higher degree of protonation than the starting material, are produced.

Such an aminopolycarboxylic acid may for example be a compound comprising at least one amine functionality and a plurality of carboxylic groups, such as EDTA and DTPA. Further, aminopolycarboxylic acids may comprise more than one amine functionality, such as 2 or 3 amine functionalities. A plurality of carboxylic groups means at least 2 carboxylic groups. Preferably, an aminopolycarboxylic acid has 3 or more carboxylic groups.

Fully deprotonated aminopolycarboxylic acid may for example be an aminopolycarboxylic acid, wherein all of the carboxylic groups are present as carboxylates, i.e. deprotonated, and none of the nitrogen(s) are protonated. Partially deprotonated and partially protonated aminopolycarboxylic acid may for example be an aminopolycarboxylic acid, which is neither fully protonated nor fully deprotonated.

A solid ion-exchanger may for example be an ion-exchanger, which may be separated from the reaction mixture through a simple filtration, such as ion exchange resins and ion exchange beads.

Although the use of a solid ion-exchanger is preferred, it is also possible to use a liquid cation exchanger to form a partially deprotonated aminopolycarboxylic acid from a partially or fully deprotonated aminopolycarboxylic acid. The only requirement is that it should be possible to separate the formed partially deprotonated aminopolycarboxylic acid from the cation exchanger. In the case of using a liquid cation exchanger it is preferred if the cation exchanger is a weak to moderately strong cation exchanger.

The partially protonated form of the aminopolycarboxylic acid may be separated from the cation-exchanger. In such embodiment, essentially all, such as more than 95%, of the chelating species present in a solution or a composition comprising the partially or fully deprotonated aminopolycarboxylic acid, will be present also in the corresponding solution or composition. This solution or composition will comprise the partially protonated forms of the aminopolycarboxylic acid with higher degree of protonation than the starting material. Further, as a partially protonated form of the aminopolycarboxylic acid is formed, there is no need for a separate step wherein a fully protonated aminopolycarboxylic acid is reacted with a base to form the partially protonated form of the aminopolycarboxylic acid of interest.

A fully protonated aminopolycarboxylic acid may for example be an aminopolycarboxylic acid, which is present as a neutral compound although it may be zwiterionic, i.e. the number of acidic protons corresponds to the number of carboxylic groups although said protons may be present on the amino functionality/functionalities as this residue is basic.

Technical fully deprotonated aminopolycarboxylic acids, such as EDTANa₄ or DTPANa₅, also comprise other chelating aminopolycarboxylic acid. These other chelating aminopolycarboxylic acids comprise NTA. Further, they comprise aminopolycarboxylic acids comprising a lower number of carboxylic groups than the parent compound. Such aminopolycarboxylic acids, comprising a lower number of carboxylic groups than the parent compound, may be EDTriANa₃ and EDDiANa₂ in the case of technical EDTANa₄ and DETATetA-Na₄ and DETATriA-Na₃ in the case of technical DTPANa₅. These aminopolycarboxylic acids, which comprise a lower number of carboxylic groups than the parent compound, may be aminopolycarboxylic acids wherein not all of the available amino group(s) have been fully carboxylated.

In solutions of partially protonated forms the aminopolycarboxylic acid with higher degree of protonation than the starting material, which may be produced via reaction with a solid acidic protonated cation exchanger, 1 to 15 wt %, such as 7 to 12 wt %, of the chelating species may be NTA. Further, 1 to 15 wt %, such as 1 to 5 wt %, of the chelating species may be aminopolycarboxylic acids comprising a lower number of carboxylic groups than the parent compound. Additionally, 70 to 98 wt %, such as 82 to 92 wt %, of the chelating species may be the parent aminopolycarboxylic acid. The chelating value of such a solution may be at least 10%, such as more than 30%.

In another embodiment according to the invention, a technical aqueous solution of technical DTPANa₅ is reacted with a solid acidic protonated cation-exchanger to produce aqueous solutions of partially protonated forms of DTPANa5, such as DTPANa₃H₂ and/or DTPANa₂H₃. A technical aqueous solution of technical DTPANa₅ may for example be an aqueous solution with a content of chelating species corresponding to 40 wt % DTPANa₅, i.e. all the chelating species are regarded as DTPANa₅ when the active content are determined. An example of a technical solution comprising DTPANa₅ is VERSENEX 80, which is sold under this trademark by DOW. The aqueous solution of partially protonated forms of DTPANa₅ may be separated from the cation-exchanger. Substantially all of the chelating species present in the starting material, e.g. technical DTPANa₅, will also be present in the aqueous solution of partially protonated forms of DTPANa₅. Accordingly, there is no considerable loss of chelating species. In such a solution 70 to 98 wt %, such as 82 to 92 wt %, of the chelating species may be partially protonated forms of DTPANa₅. Further, 1 to 15 wt %, such as 7 to 12 wt %, of the chelating species may be NTA. Additionally, 1 to 15 wt %, such as 1 to 5 wt %, of the chelating species may be partially protonated forms of aminopolycarboxylic acids comprising a lower number of carboxylic groups than the DTPA, e.g. DETATetA and DETATriA. The chelating value of such a solution may be at least 10%, such as more than 30% or even more than 50%.

The use of a solid cation-exchanger allows for simple separation of the cation-exchanger from the aqueous solution of partially protonated forms of aminocarboxylic acids, such as partially protonated forms DTPANa₅.

Furthermore, solutions produced in this way have the advantage of being substantially free from inorganic salts, such as comprising less than 1 wt % or even less than 0.1 wt % of inorganic salts, or at least free from inorganic salts such as different salts of alkali metals; salts of alkaline earth metals; sulphates; halides, such as chlorides; and nitrates. Especially, such solutions will be essentially free from the base, such as comprising less than 1 wt %, less than 0.1 wt % or even less than 0.01 wt % of the base, corresponding to the acid used to protonate the aminocarboxylic acid, such as DTPANa₅, as this will be the deprotonated cation-exchanger separated from the aqueous solution of partially protonated form of the aminocarboxylic acid. This means that such solutions may be essentially free from chloride, such as comprising less than 1 wt %, less than 0.1 wt %, or even less than 0.01 wt % of chloride, if hydrochloric acid is used as the above-mentioned acid.

For example, the content of sodium chloride in aqueous solutions of protonated forms of DTPANa₅ may comprise less than 1 wt % sodium chloride, such as less than 0.1 wt % or even being essentially free from such sodium chloride. Such aqueous solutions may have a content of chelating species corresponding to more than 50 wt % sodium salts of DTPA, such as DTPANa₃H₂. Although not all chelating species may be sodium salts of DTPA, all the chelating species are regarded as sodium salts of DTPA, such as DTPANa₅, when the active content is determined. An aqueous solution, as disclosed above, may have DTPA stoicheiometry of about DTPANa₃H₂ to DTPANa₂H₃, such as DTPANa_{2.5±0.3}H_{2.5±0.3}; DTPANa_{3±0.3}H_{2±0.3}; or DTPANa_{2±0.3}H_{3±0.3}.

Partially protonated forms of EDTA and other aminopolycarboxylic acids may be formed in a similar way. Such partially protonated forms aminopolycarboxylic acids will have a low content, such as less than 1 wt % or even less than 0.1 wt %, of inorganic salts, or at least a low content of inorganic salts such as different salts of alkali metals; salts of alkaline earth metals; sulphates; halides, such as chlorides;or nitrates. Especially, a solution comprising such a partially protonated form of a aminopolycarboxylic acids will be essentially free, such as comprising less than 1 wt %, less than 0.1 wt % or even less than 0.01 wt %, from the base corresponding to the acid used to protonate the deprotonated aminopolycarboxylic acid, as disclosed above.

It was surprisingly found, that aqueous solutions of partially protonated forms of DTPANa₅ remained non-viscous liquids a much higher concentrations compared to aqueous solutions of DTPANa₅. Concentrated aqueous solutions of partially protonated forms of DTPANa₅ may be formed by evaporating an aqueous solution of partially protonated forms of DTPANa₅. Furthermore, the solubility of partially protonated forms of DTPANa₅ in water was shown to be much higher than the solubility of DTPA.

Especially aqueous solutions with a DTPA stoicheiometry of DTPANa₃H₂ to DTPANa₂H₃, such as DTPANa_{3±0.3}H_{2±0.3}, may be produced at much higher concentrations, such as concentration of over 60 wt % (chelating species are regarded as DTPANa₃H₂ when the active content are calculated), than corresponding aqueous solutions of technical DTPANa₅ according to the prior art. Even at concentrations above 70 wt % (chelating species are regarded as DTPANa₃H₂ when the active content are calculated) aqueous solutions of partially protonated DTPA with a DTPA stoicheiometry of DTPANa₃H₂ to DTPANa₂H₃, such as DTPANa_{3±0.3}H_{2±0.3}, remains non-viscous, easily pourable liquids at room temperature. Even at temperatures below room temperature, such as at 10° C. or even −10° C., such liquids remain non-viscous. As aqueous solutions of technical DTPANa₅ get very viscous at concentrations above 50 wt % (chelating species are regarded as DTPANa₅ when the active content are calculated), the invention, for one example, allows for transportation of more concentrated solutions comprising DTPA.

In another embodiment according to the invention, a weak or a moderately solid strong acidic protonated cation-exchanger is used to produce partially protonated forms of deprotonated aminocarboxylic aminoacids, such as DTPANa₃H₂. A weak or a moderately solid strong acidic protonated cation-exchanger may be a cation-exchanger with half neutralisation pH between about 2 and about 10. Further, the weak or a moderately strong a cation-exchanger may be used in excess, such as slight to moderate excess. This, as weak or a moderately strong a cation-exchanger have a buffer like behaviour and giving rise to a fairly constant pH when exposed to between 1 and 3 equivalents of a base. Excess is intended to mean more than stoicheometricly required to achieve the desired degree of protonation. Slight to moderate excess may be 1.1 to 10, such as 1.1 to 5 or 1.1 to 3, times the number of equivalents required to achieve the desired degree of protonation.

According to another embodiment, only a part of the full capacity of the weak or a moderately solid strong acidic protonated cation-exchanger is used, by applying an excess of the ion exchanger. Such a part may be 10 to 80%, such as 30 to 60%, of the full capacity of the cation-exchanger. By only using a part of the full capacity cation-exchanger, its lifetime may be extended. Accordingly, the cation-exchanger may be used for larger number of cycles if only a part of its full capacity are utilized.

The advantages of using a weak or a moderately solid strong acidic protonated cation-exchanger excess are several. First, the caustic normally present in technical deprotonated aminocarboxylic aminoacids, such as DTPANa₅, will be neutralized and the hydroxide counter ion, e.g. sodium, will be bound to the cation-exchanger. Secondly, whereas all the acidic sites of the cation exchanger have substantially the same degree of acidity, all the acid sites in the chelating agent are different. As a consequence, the degree of protonation of the deprotonated aminocarboxylic aminoacids, such as DTPANa₅, will mainly depend on the acidity of the protonated acidic cation-exchanger, and to less extent on the amount of the cation-exchanger applied. By choosing different types of cation-exchangers and by using different degrees of excess, different degrees of protonation may be achieved. After separating the cation-exchanger, it may easily be regenerated by use of a strong acid, such a strong mineral acid, e.g. sulphuric acid and hydrochloric acid.

According to another embodiment of the invention, an cation-exchanger with a half neutralisation pH between 4 and 7, such as about 6, may be used to produce a partially protonated form of DTPANa₅. An example of such a cation-exchanger is a poly acrylic acid cation-exchanger, e.g. Bayer CNP 80 WS. Such a partially protonated form of DTPANa₅ will have a stoicheiometric formula corresponding to DTPANa₃H₂ to DTPANa₂H₃. The exact stoicheiometric formula will depend on the excess applied. By using cation-exchangers with other pK_{A}-values and/or larger excess, protonated forms of DTPANa₅ with any stoicheiometric formula may be produced.

Similarly, different forms of other aminopolycarboxylic acid may be produced. As an example EDTA with a stoicheiometric formula corresponding to EDTANa_{2±0.5}H_{2±0.5} may be produced in a similar way.

Instead of using a somewhat stronger ion-exchanger to achieve a higher degree of protonation, it is possible to use a solid strong acidic ion-exchanger in stoicheometric amount in a second step to achieve the desired degree of protonation. As an example an aqueous solution with a DTPA stoicheiometry of DTPANa₃H₂ to DTPANa₂H₃ may be treated with a desired amount of a strong ion-exchanger to produce aqueous solution with a DTPA stoicheiometry of about DTPANa_{1.3±0.3}H_{3.7±0.3}. This is advantageous, compared to only using a strong acidic ion-exchanger, as it requires less of the strong ion-exchanger and as discussed below, strong ion-exchanger may be difficult to regenerate.

The one skilled in the art will be able to predict the pH to be achieved from a diagram of the distribution of ionic species of an aminopolycarboxylic acid, such as DTPA, in aqueous solution vs. pH. Thus, the skilled person could predict the strength and the amount of cation-exchanger to be used, to produce aminopolycarboxylic acid specie, such as a DTPA-specie, with the desired degree of protonation, such as DTPANa₃H₂. Such diagram may, for an example, be found in “KEYS to Chelation” issued by Dow Chemical Company in 2000. The one skilled in the art will also be familiar with how to choose such acidic protonated cation-exchanger from a commercial supplier. On example of a commercial supplier of cation-exchangers is Rhom and Haas. Further, the one skilled in the art will also be guided by the experimental data given below in choosing suitable excess to be used.

A protonated strong acidic solid cation-exchanger, such as crosslinked polystyrene 3-sulphonic acid, may be used in a stoicheiometric amount to neutralize any basic salts, such as hydroxide salts, present in deprotonated technical aminopolycarboxylic acids, such as technical DTPANa₅. Further, it may be used in a stoicheiometric amount to achieve the desired degree of protonation of an aminopolycarboxylic acid, such as DTPANa₅. Compared to a weak or a moderately strong cation-exchanger, a strong cation-exchanger is harder to regenerate and requires the use of a large excess of a strong acid, such as concentrated hydrochloric acid.

If the two-step procedure discussed above is used, the weak or a moderately strong cation-exchanger may be regenerated by use of the same acid used to regenerate the strong cation-exchanger instead of just discarding it.

If the produced aqueous solution of the partially protonated aminopolycarboxylic acids has a too high degree of protonation, it is possible to add a base, such as sodium hydroxide or ammonium hydroxide, to decrease the degree of protonation and to achieve the desired degree of protonation. Compared to using a fully protonated aminopolycarboxylic acid, this requires less base. Further, all chelating species present in the fully deprotonated aminopolycarboxylic acid used to produced the fully protonated aminopolycarboxylic will also be present in the partially protonated aminopolycarboxylic acid.

If the produced aqueous solution of the partially protonated aminopolycarboxylic acids has a somewhat too low degree of protonation, it is possible to add an strong organic acid, such as, but not limited to, formic acid, oxalic acid, methanesulphonic acid or hydroxyacetic acid, to increase the degree of protonation and to achieve the desired degree of protonation. Compared to using a deprotonated aminopolycarboxylic acid, this requires less acid. Further, all chelating species present in the fully deprotonated aminopolycarboxylic acid used to produced the partially protonated aminopolycarboxylic will also be present in the partially protonated aminopolycarboxylic acid with higher degree of protonation.

The solid protonated acidic cation-exchanger may be added, in an amount suitable to achieve the desired degree of protonation, to a tank, wherein an aqueous solution of a deprotonated aminopolycarboxylic acid is present. Similarly, an aqueous solution of a deprotonated aminopolycarboxylic may be added to a tank, wherein a solid protonated acidic cation-exchanger is present, in an amount suitable to achieve the desired protonation. If a strong cation-exchanger is used the former is preferred, as to avoid precipitation of fully protonated aminopolycarboxylic acid, which may be formed initially. Further, the degree of protonation may be determined from the pH of the solution. The pH may be adjusted by the addition of more cation-exchanger or a base, such as caustic. As discussed above, the acidity of a weak or moderately strong cation-exchanger used in slight excess will mainly determine the degree of protonation. After the cation-exchange have taken place the aqueous solution of the partially deprotonated aminopolycarboxylic acid may be removed from the tank to separate the cation-exchanger from the partially deprotonated aminopolycarboxylic acid. An aqueous solution of a deprotonated aminopolycarboxylic acid may also be pumped through a column loaded with a solid cation-exchanger or an cation exchange resin and whereby allowing ion exchange to take place. Such a solution may be pumped several times through the same column to establish equilibrium.

The aqueous solutions comprising partially protonated forms of DTPANa₅ and other aminopolycarboxylic acids have a large range of applications, e.g. in substituting aqueous solutions of DTPANa₅ or other aminopolycarboxylic acids in different uses. This uses may include agriculture uses, horticulture uses, cleaning formulations, cosmetic and toiletry uses, food applications, metalworking uses, oil field uses, pharmaceutical uses, photography applications, polymerization, pulp and paper uses, scale removal and prevention, soap uses, textile uses and water hardness uses. Such uses are disclosed in disclosed in “KEYS to Chelation” issued by Dow Chemical Company in 2000. As already discussed, the aqueous solutions of partially protonated forms of DTPANa₅ according to the invention, has a number of advantages over aqueous solutions of technical DTPANa₅, said advantages include but are not limited to: improved product safety as pH is reduced, reduced storing, packing and transport costs as a consequence of the improved water solubility and improved characteristics for preparation of salt-free metal chelates.

An aqueous solution of DTPANa₃H₂ is further useful in the manufacture of aqueous solutions of DTPAFe(III)NaH. DTPAFe(III)NaH produced in this way may be essentially free from sodium chloride. Further it may be free from other inorganic salts.

In one embodiment, an aqueous solution of FeCl₂ is used to replace the counter cation present, e.g. sodium, in a deprotonated solid cation-exchanger. Such a deprotonated solid acidic cation-exchanger is preferably a weak or moderately strong deprotonated cation-exchanger. Preferably, the counter ion in said cation-exchanger is sodium. Said cation-exchanger may previously have been used to partially protonate a fully or partially deprotonated aminopolycarboxylic acid, such asDTPANa₅. Fe²⁺ will be more strongly bound to the cation-exchanger than Na⁺ and consequently sodium is easily replaced by iron in an acidic cation-exchanger. The cation-exchanger, in which sodium has been replaced by iron, is easily separated from the aqueous solution comprising sodium chloride, after exchange of sodium an iron have taken place. After the cation-exchanger has been separated from aqueous solution comprising sodium chloride, it may be rinsed with water to remove any remaining sodium chloride.

Similarly, sodium or other monovalent cations, such as potassium or lithium, may be replace with iron or other di- or trivalent cations, such as ions of calcium, zinc, copper, manganese and magnesium, in the cation-exchanger. Similarly to what have been disclosed above, such ion exchange may take place in a tank, with or with-out stirring, or in a column through which an aqueous solution with the ion to replace the ion present within the cation-exchanger is pumped.

The cation-exchanger loaded with Fe²⁺, may then be used to replace two of the sodium atoms in DTPANa₃H₂ in an aqueous solution with Fe²⁺ to form DTPAFe(II)NaH₂. Similarly, other metal chelates, such as DTPAMgNaH and DTPACu(II)NaH, may be produced. By separating the produced aqueous solution DTPAFe(II)NaH₂ from the cation-exchanger, an aqueous solution of DTPAFe(II)NaH₂ may be produced. Such a solution may be essentially free from sodium chloride. Further, it may be essentially free from other inorganic salts. After the cation-exchanger have been separated from aqueous solution comprising DTPAFe(II)NaH₂, it may be rinsed with water to recover any remaining DTPAFe(II)NaH₂. As already discussed, the cation-exchanger may easily be regenerated by use of a strong acid, such a strong mineral acid, e.g. sulphuric acid and hydrochloric acid.

A strong cation-exchanger will bind di- or trivalent cations more strongly than a weak or moderately strong cation-exchanger. Therefore, it is preferred to use a weak or moderately strong cation-exchanger, as the ion exchange will take place more rapidly and under less harsh conditions with such cation-exchanger.

Further, such cation exchange may take place in a tank, with or with-out stirring, or in a column through which an aqueous solution aqueous solution of DTPANa₃H₂ or other partially protonated aminopolycarboxylic acids is pumped.

The aqueous solution of DTPAFe(II)NaH₂ may then be exposed to oxygen, such as aerial oxygen, or another oxidizing agent, in order to achieve oxidation of Fe(II) to Fe(III) to form DTPAFe(III)NaH. Such oxidation may also be performed simultaneously with the ion exchange disclosed above.

The loading of the di- or trivalent cation and the subsequent cation exchange may also be performed under essentially oxygen free conditions. By using oxygen free conditions, oxidation of the species present, such as Fe(II)²⁺, may be avoided.

In another embodiment, an aqueous solution of DTPANaH₄, produced according to the present invention, is exposed to Fe₃O₄ to form an aqueous solution comprising DTPAFe(II)NaH₂ and DTPAFe(III)NaH. Said DTPAFe(II)NaH₂ may then be oxidized with aerial oxygen to form an aqueous solution comprising DTPAFe(III)NaH.

According to an aspect of the invention, there is disclosed an aqueous solution of DTPAFe(III)NaH. Said solution may be essentially free from sodium chloride, such as comprising less than 1 wt %, less than 0.1 wt % or even less than 0.01 wt % sodium chloride. Further, it may be free from other inorganic salts, such as comprising less than 1 wt % or even less than 0.1 wt % of inorganic salts. The concentration of DTPAFe(III)NaH in such a solution may vary. Such a solution may have a concentration of chelated iron higher than 3.0 to 3.5 wt %, such as higher than 5 wt %. As the solution may be essentially free from sodium chloride it may have a concentration of chelated iron higher than 3.0 to 3.5 wt %, which normally is seen as an over limit for the iron content in aqueous solutions of DTPAFe(III)NaH. The concentration of chelated iron in such a solution may even correspond to about 6 wt % iron or higher.

In contrast to an aqueous solution of DTPAFe(III)NH₄H made from DTPA, which DTPA is prepared from technical DTPANa₅, essentially all of the chelating species present in the starting material, i.e. technical DTPANa₅, may also be present in an aqueous solution of DTPAFe(III)NaH according to another aspect of the present invention. In such a solution 70 to 98 wt %, such as 82 to 92 wt %, of the iron may be chelated by DTPA; 1 to 15 wt %, such as 7 to 12 wt %, by NTA; and 1 to 15 wt %, such as 1 to 5 wt %, by aminopolycarboxylic acids comprising a lower number of carboxylic groups than the DTPA, such as DETATetA and DETATriA. As a consequence, such an aqueous solution of DTPAFe(III)NaH, which is essentially free from sodium chloride may be used in a wider range of applications than a solution also comprising sodium chloride. Such a solution may be used in agriculture uses, horticulture uses or photographic applications. The agriculture and horticulture use may be as a fertilizer.

Furthermore, an aqueous solution of partially protonated DTPANa₅, such as DTPANa₃H₂, is useful in the manufacture of aqueous solutions of metal chelates of DTPA, such as DTPAMgNaH and DTPACu(II)NaH. Such solution may be essentially free from sodium chloride, such as comprising less than 1 wt %, less than 0.1 wt % or even less than 0.01 wt % sodium chloride. Further, it may be essentially free from other inorganic salts, such as comprising less than 1 wt %, or even less than 0.01 wt % of inorganic salts.

The use of oxides and hydroxides, as source of the metal ion to form the chelate, means that the partial protonation and the metal ion exchange may be performed simultaneously or subsequently without any intermediate separation. In such an embodiment, the deprotonated aminopolycarboxylic acid, such as DTPANa₅, may be mixed with a protonated acidic ion cation exchanger and a metal hydroxide, such as Fe(OH)₂, or metal oxide, such as MnO, CaO and CuO. After protonation and ion-exchange have taken place, the metal chelate of the partially protonated aminopolycarboxylic acid, such as DTPAMgNaH, may be separated from the cation exchanger. After the product has been separated form ion-exchanger the pH of the resulting solution may be adjusted by using a base. Although such adjustment not is necessary, it may be advantageous to stabilize the chelate formed.

In another embodiment, an aqueous solution of DTPANa₅, a protonated cation-exchanger, such as a weak or moderately strong cation-exchanger, and copper(II) oxide (CuO) are reacted to form DTPACu(II)NaH. After the product have been separated form ion-exchanger the pH of the resulting solution may be adjusted, such as adjusted to pH 6.5, by using a base.

Other aspects of the invention relates to methods to produce such aminopolycarboxylic acids as have been disclosed above. Accordingly, the disclosure of different aspects and features made above are applicable also to methods according to the present invention.

According to such another aspect of the invention there is disclosed a method of producing an aqueous solution of partially deprotonated aminopolycarboxylic acid from a partially or fully deprotonated aminopolycarboxylic acid.

In such a method there may be provided a solution of a partially or fully deprotonated aminopolycarboxylic acid. The partially or fully deprotonated aminopolycarboxylic acid may be a sodium salt. The solution may be an aqueous solution of DTPANa₅, such as an aqueous solution of technical DTPANa₅. Further, the solution of a partially or fully deprotonated aminopolycarboxylic acid may be brought in contact with a solid weak or moderately strong acidic cation exchanger in its protonated form. As a result any caustic present in the solution will neutralized. Further, the partially or fully deprotonated aminopolycarboxylic acid will be protonated. The extent of the protonation will depend mainly on the strength of cation-exchanger and to some extent of the amount used, but the aminopolycarboxylic acid will not be fully protonated if weak or moderately strong acidic cation exchanger is used.

Further, a di- or trivalent cation, in form of a hydroxide or an oxide, may be added. Examples of such hydroxides and oxides include, but are not limited to, iron(II)hydroxide (Fe(OH)₂), copper(II) oxide (CuO), manganese oxide (MnO) and calcium oxide (CaO).

The produced solution of a partially deprotonated aminopolycarboxylic acid, wherein the degree of protonation is higher than in the starting material may then be separated from the solid cation-exchanger. The resulting solution will be essentially free from sodium chloride, such as comprising less than 1 wt %, less than 0.1 wt %, or even less than 0.01 wt % sodium chloride. Further, it may be essentially free from other inorganic salts, such as comprising less than 1 wt %, or even less than 0.1 wt % of inorganic salts. Examples of partially or fully deprotonated aminopolycarboxylic acid which may be produced in this way comprise, but are not limited to, DTPA with a stoicheometry of DTPANa₃H₂ to DTPANa₂H₃, such as DTPANa₃H₂, and DTPACu(II)NaH.

In another aspect of such a method a disclosed above, the counter ion, such as sodium, in the solid cation-exchanger used to protonate partially or fully deprotonated aminopolycarboxylic acid may be replaced with a di- or trivalent cation. This di- or trivalent cation may be added as an aqueous solution to the cation-exchanger. Such an aqueous solution may comprise iron. The iron may be in the form of Fe(II)Cl₂ or Fe₃O₄. Then, a solution of a partially protonated aminopolycarboxylic acid, such as the ones disclosed above, e.g. an aqueous solution with a DTPA stoicheometry of about DTPANa₃H₂, may be brought in contact with a cation-exchanger comprising di- or trivalent cation.

The cation-exchanger comprising a di- or trivalent cation and to be brought in contact with the partially protonated aminopolycarboxylic acid may also be different from the cation-exchanger used to form a partially protonated aminopolycarboxylic acid. By using different ion-exchangers, an optimal cation-exchanger may be selected for each step. On the other hand, it may be convenient to use the same cation-exchanger for both steps.

The thus formed aqueous solution of di- or trivalent metal chelate of a partially protonated aminopolycarboxylic acid may then be separated from the cation-exchanger. Subsequently, the pH of the aqueous solution may be adjusted. Such adjustment is not necessary, but may be advantageous for optimal stability of the chelate. As an example, the pH may be adjusted to about 6.5 in solutions comprising metal chelates of DTPA. Such a method may be utilized to produce aqueous solutions comprising metal chelate of a partially protonated aminopolycarboxylic acid such as, but not limited to, DTPAFe(II)NaH₂ and DTPAFe(III)NaH.

In order to produce solutions comprising DTPAFe(III)NaH from solutions comprising DTPAFe(II)NaH₂, said solution may be exposed to oxygen, such as aerial oxygen. The oxidation may be performed simultaneously with ion exchange. Further, it may be performed subsequent to the ion exchange, but prior to the separation of the metal chelate of the partially protonated aminopolycarboxylic acid from the cation-exchanger. It may also be performed after the separation of the metal chelate of the partially protonated aminopolycarboxylic acid from the cation-exchanger.

Such a oxidation may be utilized to produce aqueous solutions comprising metal chelates of a partially protonated aminopolycarboxylic acid such as, but not limited to, DTPAFe(III)NaH.

Further, the use of a separate cation-exchanger comprising a divalent cation disclosed above may be advantageous in case wherein ion-exchange involving divalent cations, which may be oxidized, e.g. Fe(II)²⁺, are to be performed under oxygen free conditions to avoid oxidation. Oxygen free conditions may also be used if the same cation exchanger is used. By use of oxygen free conditions, also metal chelates of species, which otherwise may oxidized, may be produced.

If technical fully deprotonated aminopolycarboxylic acid, such as technical DTPANa5, is used as starting material in the methods disclosed above, the produced partially deprotonated aminopolycarboxylic acid will be essentially free from sodium chloride, such as comprising less than 1 wt %, less than 0.1 wt % or even less than 0.01 wt %. Further, they will be essentially from other inorganic salts, such as comprising less than 1 wt % or even less than 0.1 wt % of inorganic salts. Additionally, essentially all of the chelating species in the starting material partially will be present in a solution comprising the partially protonated aminopolycarboxylic acid produced in this way. Examples of such partially protonated aminopolycarboxylic acid are, but not limited to, DTPAFe(III)NaH, DTPA with a stoicheometry of DTPANa₃H₂ to DTPANa₂H₃, such as DTPANa₃H₂, and DTPACu(II)NaH.

Although the present invention has been described above with reference to specific illustrative embodiments, it is not intended to be limited to the specific form set forth herein. Rather, the invention is limited only by the accompanying claims and other embodiments than the specific above are equally possible within the scope of these appended claims.

In the claims, the term “comprises/comprising” does not exclude the presence of other species or steps. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality.

### EXAMPLES

The examples given below are only intended to further illustrate the invention and are by no means intended to limit the scope of the invention as defined by the appended claims.

### Example 1

### Production of an Aqueous Solution of DTPANa₃H₂

A column, 100×5 cm, suitable for ion exchange was provided with feeding and recirculation pumps. The re-circulation loop contained a small in line compartment for measurement of pH and conductivity of the liquid phase in circulation. Further, the column was provided with a manually operated dropping funnel for holding, when necessary, excessive recirculation liquid phase.

The column was then charged with a dispersion of 500 gram of weak ion exchange beads (Bayer CNP 80 WS, 2.98 equivalents per kg) in 672 gram de-ionized water. After de-airing the ion exchange bed, 614 gram (0.50 mol) technical liquid DTPANa₅, Dow Versenex 80E, 41% DTPANa₅) was charged in the column. At the same time, a liquid phase was withdrawn from the top 10 cm above the bed level and re-circulated to the bottom inlet.

When the DTPANa₅ charging had been completed, the liquid phase was re-circulated for 30 minutes. The pH of the liquid phase had then been stable for ten minutes at about pH 5.1.

The liquid phase, i.e. the product solution, was then withdrawn from the bottom of the column, while keeping the liquid phase at a constant level (10 cm above the bed level) by feeding de-ionized water to the top.

The product solution was collected in 10 fractions of 250 gram each. All samples were analysed for chelation value, which were calculated as DTPANa₅, i.e. the determined chelation value (or active content) corresponds to wt % of DTPANa₅, and densities. These data are summarized in table 1.

TABLE 1
Properties of the product solution comprising DTPANa₃H₂

| Fraction | | | Chelation | Cumulative |
|---|---|---|---|---|
| No | Density | pH | Value (%)* | Yield % |
| 1 | 1.079 | 5.2 | 40.8 | 16.1 |
| 2 | 1.075 | 5.2 | 40.7 | 32.1 |
| 3 | 1.079 | 5.2 | 40.6 | 48.1 |
| 4 | 1.079 | 5.3 | 40.6 | 64.1 |
| 5 | 1.079 | 5.2 | 40.8 | 80.1 |
| 6 | 1.079 | 5.2 | 36.9 | 94.7 |
| 7 | 1.072 | 5.5 | 7.3 | 97.6 |
| 8 | 1.000 | 6.4 | 0.9 | 97.9 |
| 9 | 0.999 | 7.0 | 0.2 | 98.0 |
| 10 | 0.999 | 7.2 | 0.02 | — |

*The chelation values were calculated as if DTPANa₅, i.e. MW = 503 were used in the calculation of the chelation value, were the only chelating specie present, as to make a direct comparison with the starting material possible.

The cumulative yield is calculated from the sum determinations and may include a minor systematic error. Accordingly, the actually yield is regarded as quantitative. The analytical data are calculated using the conventional nomination DTPANa₅ Mol weight 503.

The composition of the actual product is calculated from determinations of chelation value and sodium contents of the mixed and concentrated fractions and corresponds to a stoicheometry of about DTPANa₃H₂.

At room temperature, the product solution, concentrated to 614 g, is a clear and bright, low viscosity solution having a density of 1.23 and a chelation value of 41% (calc. as DTPANa₅), determined by potentiometric titration with ferric chloride. The product solution is referred to as Solution A. Storing of Solution A at minus 10° C. for 6 month did not cause any precipitations or change in appearance other than a somewhat increased viscosity at the lowest temperature

Several batches of Solution A, all having the same characteristics, were made for further studies.

### Example 2

### Studies of the Viscosity of Aqueous Solution of DTPANa₃H₂ Compared to the Viscosity Aqueous Solutions of DTPANa₅

A large batch of 1038 gram of Solution A comprising 0.86 mol of the DTPANa5 equivalent DTPANa₃H₂ was concentrated to 572 gram corresponding to an concentration of about 69 wt % DTPANa₃H₂, which corresponds to an apparent concentration of about 75 wt % DTPANa₅.

The product solution is referred to as Solution A Concentrate. Solution A Concentrate was a clear, bright solution with low viscosity at room temperature, which solution has a density of 1.438 and a pH of 6.3. Said solution comprises chelating species derived from a solution of technical DTPANa₅, corresponding to 0.86 mol DTPANa₅. This is in contrast to solutions of DTPANa₅, which get too viscous to allow convenient handling at concentrations above 40 wt %, such as 50 wt %.

The solution was stored at room temperature, at 0° C. and −10° C. for six months without any visible changes other than a somewhat higher viscosity at the lowest temperature.

### Example 3

### Production of an Aqueous Solution of DTPAFe(III)NaH from DTPANa₃H₂ via Ion Exchange and Subsequent Oxidation

The beads remaining in the ion exchange column of Example 1, containing about 1.5 gram sodium extracted from 0.50 mol technical DTPANa₅, with a total sodium content of 10 wt %, were treated with an aqueous solution comprising about 0.50 mol freshly prepared ferrous chloride, which were made from ferric chloride and iron powder for minimum content of hydrochloric acid. The excess of sodium in the beads is a result of the excess of free caustic in the technical DTPANa₅. The sodium excess can be increase if faster exchange with the ferric choride is desired. Also the charge of ferric chloride may be increased to the caustic molar level minus about 5%. This may be advantageous in the case wherein ion-exchange involving divalent cations, which may be oxidized, e.g. Fe(II)²⁺, are performed in a separate unit suitable for oxygen free conditions. Such oxygen free conditions may be used to avoid oxidation of divalent species, such as Fe(II)²⁺.

The solution was fed into the bottom inlet, and at the same time, a corresponding volume liquid phase was withdrawn from the top and re-circulated to the bottom inlet. The liquid phase was re-circulated for an hour and then withdrawn from the bottom of the column. The resulting solution was free from ionic iron. Accordingly, the ferrous ions have replaced the sodium ions previously fixed to the ion exchanger.

The beads were then rinsed with de-ionized water until the water is essentially free from sodium chloride and other ions as determined by in line conductivity measurements.

The beads in ferrous form remaining in the column were then treated with Solution A from Example 1, containing 0.50 mol chelating agent. Solution A was fed from the bottom of the column while re-circulating the liquid phase from the top to the bottom inlet for 1 hour. Ion exchange occurred to give the ferrous chelates, e.g. DTPANaFe(II)H₂, quantitatively.

The liquid phase, i.e. the product solution, was then withdrawn and the ion exchanger beads were rinsed with de-ionized water. The product solution and the rinsing water were combined and aired for oxidation to the ferric chelate to occur. In order to facilitate the oxidation, the pH may initially be adjusted to about 6.5 by addition of small amounts of ammonia, sodium hydroxide or some other suitable alkaline compound, but such adjustment is not necessary. After completed oxidation, as determined by UV-absorption, the solution was concentrated to contain about 6% of chelated iron, mainly as DTPAFe(III)NaH. The pH may then be adjusted to 6.5 to 7.0 if desired.

Samples of the product solution were stored for 6 months at room temperature, at 0° C. and at −10° C. without causing any precipitations. The only change observed at the lower temperatures was an increase in viscosity of the solutions.

After regeneration of the ion exchanger with dilute hydrochloric acid, a new sequence of cycles corresponding to Examples 1 and 3 may be initiated.

### Example 4

### Use of Various Excess of Cation-Exchanger

The effect on sodium elimination from the chelating agent, i.e. the protonation of the chelating agent, was investigated at 20 and 60° C. by increasing in five steps the charges of the ion exchanger Bayer CNP 80 WS from 2.51 to 3.40 equivalents per 1.00 mol of technical DTPANa₅. The results are shown in Table 2 and 3. The experimental procedures were the same as the one used in example 5 below except that no cupric oxide was added.

TABLE 2
Experiments conducted at 20° C.

| | Experiment no | | | | |
|---|---|---|---|---|---|
| | 1 | 2 | 3 | 4 | 5 |
| Versenex 80E mol | 1.00 | 1.00 | 1.00 | 1.00 | 1.00 |
| IE 80 WS eq. | 2.51 | 2.71 | 2.96 | 3.10 | 3.40 |
| pH of reaction mixture | 4.6 | 4.3 | 4.3 | 4.2 | 4.1 |
| Total Na at start/DTPA eq. | 5.3 | 5.3 | 5.3 | 5.3 | 5.3 |
| Na in Solution A/DTPA eq. | 3.0 | 2.7 | n.d.* | 2.6 | 2.1 |

*n.d. = not determined

TABLE 3
Experiments conducted at 60° C.

| | Experiment no | | | | |
|---|---|---|---|---|---|
| | 1 | 2 | 3 | 4 | 5 |
| Versenex 80E mol | 1.00 | 1.00 | 1.00 | 1.00 | 1.00 |
| IE 80 WS eq. | 2.51 | 2.71 | 2.96 | 3.10 | 3.40 |
| pH of reaction mixture | 4.2 | 4.0 | 4.0 | 4.0 | n.d.* |
| Total Na at start/DTPA eq. | 5.3 | 5.3 | 5.3 | 5.3 | 5.3 |
| Na in Solution A/DTPA eq. | 2.4 | 2.2 | n.d.* | 2.1 | 2.1 |

*n.d. = not determined

The increase of the IE charges results in both series of experiment in an increased protonation, i.e. increased sodium elimination. The increase of temperature gives increased elimination at low IE charge, but this effect seems to be marginal at higher IE charge. The product compositions may be varied with the selected process conditions from DTPANa₃H₂ to DTPANa₂H₃.

### Example 5

### Production of an Aqueous Solution of DTPACu(II)Na(NH₄)H from DTPANa₅ via Sequential Partial Protonation and Cation Exchange

A 3-necked reaction flask provided with a blade agitator, thermometer and a pH electrode were placed in a heatable water bath. The flask was charged with 275 ml of de-ionized water. While agitating at a slow rate, 450 gram of a carboxylic ion exchanger (Bayer Ion Exchanger CNP 80 WS, 2.98 equivalents per kg) was added in small portions over 5 minutes. Agitation was continued and 0.25 mol DTPANa₅ in the form of 303 gram of technical DTPANa₅ (Versenex 80E, Dow) was added over 10 minutes from a dropping funnel.

After 30 minutes the reaction mixture had stabilized at pH of 4.8 and 0.25 mol (20.0 gram) pure black cupric oxide was added. The pH-electrode was replaced by a reflux condenser and the reaction mixture was heated to about 100° C. for 2 hrs and then chilled to room temperature.

Agitation was stopped and the reflux condenser was replaced by a glass tube with a fritted end and placed at the lowest part of the reaction flask for slow withdrawing by vacuuming of the dark blue liquid phase. When completed the ion exchange bed was rinsed twice with 275 ml of de-ionized water. The liquid phases were mixed, concentrated and pH adjusted to about 6.5 with ammonium hydroxide solution to give a 6 wt % cupric DTPA chelate solution having a density of about 1.3.

The ion exchanger was regenerated by treatment with a small excess of hydrochloric acid.

### Example 6

### Production of an Aqueous Solution of Partially Protonated DTPA

To a 3-necked round bottom reaction flask provided with a blade agitator, pH electrode and a thermometer, 350 ml of de-ionized water and 312 gram (0.25 mol) Versenex 80E (Dow) were added. The mixture was agitated slowly while 285 gram of the strong acidic sulphonic cation exchanger Lewatit IE S100 H (Bayer 2.98 equivalents per kg), was added over 30 minutes.

Upon addition the temperature of the reaction mixture initially rose from 18° C. to 25° C. and then dropped to 22° C. at the end of the addition of the cation exchanger. The pH of the reaction mixture dropped from about 13 to 4.1 at the end of the acid addition.

The reaction mixture was agitated for additional 30 minutes after the pH had stabilized at 4.1. Then, the thermometer was replaced by a glass tube with the fritted end positioned at the lowest point in the reaction flask. Using this glass tube, the liquid phase was then withdrawn by vacuuming. The ion exchanger was rinsed twice with de-mineralized water and the three liquid phases were mixed and analysed for contents of chelating agents by potentiometric titration with standard ferric chloride and for sodium contents by AES (atom emission spectrometry).

The results showed that 97.6% of the chelating species remained in the product solution and the sodium contents of the product solution indicated a product composition corresponding to about DTPANa_{2.5}H_{2.5}

### Example 7

### Determination of Chelating Value

The procedures below are from “KEYS to Chelation” issued by Dow Chemical Company in 2000, which herby is incorporated by reference. According to the present invention, chelation values, when referred to in the description and in the claims, are to be determined via a potentiometric titration with FeCl₃, i.e. according to the standard in Europe.

Ferric chloride titration for active content: Titration with ferric chloride may be used to determine the active content, also referred to as chelating value. Since the chelation of Fe occurs in a 1:1 stoichiometry with most chelating agents, including NTA, the chelation value results of a ferric chloride titration may differ from the chelation value results of a calcium oxalate titration. The ferric chloride titration may be adapted to determine the chelation value of unchelated VERSENE, VERSENEX, VERSENOL, and NTA products. This method is standard in Europe.

Principle: The active content is determined by titrating the chelating agent with a solution of ferric salt using a redox electrode to detect the endpoint at the steepest mV/ml inflection. A glycine buffer is used to keep the pH in the range of 2.8 to 3.0. The use of an automatic titrator is recommended to facilitate the endpoint determination.

Reagents:

1. Glycine buffer solution. Mix approximately 150 g of reagent grade glycine in about 500 ml of deionized water in a 1500 ml beaker. While stirring on a magnetic stirrer, slowly add about 75 ml concentrated hydrochloric acid aqueous solution. Add deionized water to about 900 ml volume and cool to room temperature. Then adjust the pH to about 2.9 using a pH meter and 50% sodium hydroxide solution. Dilute to a final volume of 1 liter.

2. Sodium Hydroxide, 1 Normal solution. This reagent is used for pH adjustment and does not need to be standardized.

3. Hydrochloric Acid, 1 Normal solution. This reagent is used for pH adjustment and does not need to be standardized.

4. Ferric Chloride, 0.05 M: Dissolve approximately 13.52 g of reagent grade ferric chloride hexahydrate in one liter of deionized water. A small amount of HCl may be added to avoid precipitate formation. This solution must be standardized against a pure sample of EDTA.

Standardization of ferric chloride: To the nearest 0.1 milligram, weigh 0.08 to 0.12 g of dry, ultrapure EDTA into a suitable titration vessel. Add 40 to 80 ml of deionized water and about 2 ml 1 Normal sodium hydroxide solution and dissolve all of the EDTA. Add 15 ml glycine buffer and, if needed, add 1 Normal HCl and/or 1 Normal NaOH to obtain a pH of 2.8 to 3.0 as measured with a calibrated pH meter. Titrate with the ferric chloride solution to the steepest mV/ml inflection. For standardization purposes, it is recommended to take the average value of three or more replicate analyses.

$$Calculation \text{:}$$

$$Molarity = \frac{grams of std . E D T A acid}{ml {FeCl}_{3} titrant solution} \times 3.422$$

Procedure: To the nearest milligram, weigh a sample containing approximately 0.5 to 1 millimole of chelating agent (for example, 0.5 to 1.0 gram VERSENE 100 product) into a suitable titration vessel. Add 40 to 80 ml of distilled water and 15 ml pH 2.9 glycine buffer solution. Using a calibrated pH meter, add 1 Normal sodium hydroxide and/or 1 Normal hydrochloric acid as needed to make sure the pH is in the 2.8-3.0 range. Titrate using standardized 0.05 M ferric chloride solution to the steepest inflection point. There may be more than one inflection point, so proceed until the mV/ml response begins to level out. Titrate more slowly near the inflection points. The total chelation value is calculated from the steepest mV/ml inflection point (normally the last inflection point if more than one is present). The use of an automatic titrator is recommended.

Calculation:

$$active content ( \% wt ) = \frac{\begin{matrix}( ml {FeCl}_{3} sol . ) \times ( molarity of {FeCl}_{3} ) \times \\ molecular weight of chelant\end{matrix}}{( grams of sample ) \times 10}$$

The oxalate titration for chelation value: The oxalate titration for chelation value is an accurate and convenient method for determining chelation value of many chelant products. It is the industry standard method for chelating agents in North America. Characteristics of the calcium oxalate endpoint titration include:
The chelation of calcium occurs quantitatively and quite definitely in a 1:1 molar ratio with VERSENE 100, VERSENEX 80, VERSENOL 120, and other EDTA, DTPA, and HEDTA based products;
The materials used and apparatus needed are likely to be found in any laboratory;
The solutions used are quite stable and may be kept for long periods of time.

Principle: The total chelation value is determined by titrating with a solution of calcium salt in the presence of oxalate ion at a pH of 11.0 or slightly higher. The chelating agent will complex the calcium until an excess of calcium is present; this end point is indicated by the appearance of the white calcium oxalate precipitate.

Reagents:

1. Ammonium Oxalate Monohydrate, 3.0% solution. Dissolve approximately 30 g of ACS reagent grade (calcium-free) ammonium oxalate monohydrate in a liter of distilled water. (Prepared solutions of ammonium oxalate are also available from laboratory chemical suppliers.)

2. Sodium Hydroxide, 50%. Dissolve about 500 g of reagent grade sodium hydroxide in 500 ml of distilled water. Store in a polyethylene bottle. (Also commercially available from a variety of laboratory chemical suppliers.)

3. Calcium Chloride, 0.5 M standard solution. Dissolve approximately 73.5 g of reagent grade calcium chloride dihydrate and dilute to one liter with distilled water. (Prepared solutions of calcium chloride are also available from various laboratory chemical suppliers.) The solution is then standardized with dry, purified ethylenediaminetetraacetic acid (J.T. Baker, Ultrex EDTA, or equivalent).

0.1 milligram, weigh 2.5-3.0 g of dry, purified EDTA into a 200 ml beaker or other suitable titration vessel. Add 80 ml of distilled water and sufficient 50% sodium hydroxide to raise the pH to 11-12. Add 20 ml 3.0% ammonium oxalate monohydrate, then titrate with the calcium chloride until the first faint permanent turbidity is reached. Check pH; if it is less than 11, add enough 50% sodium hydroxide to raise the pH to above 11. If turbidity disappears, continue titration to the endpoint. For standardization purposes, it is recommended to take the average value of three or more replicate analyses.

Calculation: Molarity=((grams of std. Grade EDTA acid)/(ml CaCl2 titrant solution))*3.422

Procedure: To the nearest milligram, weigh a sample containing approximately 10 millimoles of chelating agent (for example, 10 g of VERSENE 100 product) into a clean 200 ml beaker or other suitable titration vessel. Add 85 ml distilled water and 20 ml of 3% ammonium oxalate monohydrate solution. Titrate the sample to the first faint permanent turbidity with standardized calcium chloride solution. The pH of the titration should be checked after the endpoint has been reached, using a pH meter or pH indicator paper. If the pH is below 11, add sodium hydroxide solution to raise the pH above 11. After the pH has been adjusted, the titration should be completed if the precipitate has dissolved.

$$Calculation \text{:}$$

$$\begin{matrix}\frac{\begin{matrix}\begin{matrix}( ml {CaCl}_{2} sol . ) \times \\ ( Molarity of {CaCl}_{2} sol . ) \times \end{matrix} \\ 100\end{matrix}}{( grams of sample )} = \frac{mg {CaCO}_{3}}{gram of chelating agent} \\ = chelation value\end{matrix}$$

1. A method of producing an aqueous solution of partially deprotonated aminopolycarboxylic acid from a partially or fully deprotonated aminopolycarboxylic acid, said method comprising the steps of:
providing a solution of a partially or fully deprotonated aminopolycarboxylic acid;
bringing the solution of a partially or fully deprotonated aminopolycarboxylic acid in contact with a solid weak or moderately strong acidic cation exchanger in its protonated form; and
separating the solid cation-exchanger from the produced solution of a partially deprotonated aminopolycarboxylic acid, wherein the degree of protonation is higher than in the starting material.

2. The method according to claim 1, wherein the partially or fully deprotonated aminopolycarboxylic acid is a sodium salt.

3. The method according to claim 2, wherein the partially or fully deprotonated aminopolycarboxylic acid is DTPANa₅ and the partially deprotonated aminopolycarboxylic acid formed has a stoicheometry of DTPANa₃H₂ to DTPANa₂H₃.

4. The method according to claim 1, wherein the formed solution of the partially deprotonated aminopolycarboxylic acid comprises less than 1 wt % of inorganic salts.

5. The method according to claim 1, wherein the step of bringing the solution of a partially or fully deprotonated aminopolycarboxylic acid in contact with solid weak or moderately strong acidic cation exchanger in its protonated form, further comprises bringing the solution of a partially or fully deprotonated aminopolycarboxylic acid in contact with a di- or trivalent cation, and wherein the partially deprotonated aminopolycarboxylic acid separated is a metal chelate of the aminopolycarboxylic acid comprising the di- or trivalent cation.

6. The method according to claim 5, wherein the di- or trivalent cation is added in form of metal hydroxide or metal oxide.

7. The method according to claim 1, further comprising the steps of:
replacing the counter ion in said cation exchanger with a di- or trivalent cation;
bringing the solution of a partially protonated aminopolycarboxylic acid in contact with the cation exchanger loaded with a di- or trivalent cation, to form a metal chelate of the aminopolycarboxylic acid comprising said di- or trivalent cation; and
separating the cation-exchanger from the metal chelate of the partially protonated aminopolycarboxylic acid.

8. The method according to claim 7 further comprising the step of:
oxidizing the cation in the metal chelate of the partially protonated aminopolycarboxylic acid.

9. An aqueous solution of a partially protonated aminopolycarboxylic acid, wherein 70 to 98 wt % of the chelating species are the partially protonated aminopolycarboxylic acid.

10. The aqueous solution according to claim 9, which solution has a chelating value of at least 10%.

11. The aqueous solution according to claim 10, which solution comprises less than 1 wt % of inorganic salts.

12. The aqueous solution according to claim 9, wherein 1 to 15 wt % of the chelating species in the aqueous solution is NTA.

13. The aqueous solution according to claim 9, wherein 1 to 15 wt % of the chelating species in the aqueous solution are additional partially protonated aminopolycarboxylic acids, which comprise a lower number of carboxylic groups than said aminopolycarboxylic acid but the same number of amino groups.

14. The aqueous solution according to claim 9, wherein said partially protonated aminopolycarboxylic acid is DTPA and has a stoicheometry of DTPANa₃H₂ to DTPANa₂H₃.

15. The aqueous solution according to claim 14, wherein said one or several additional partially protonated aminopolycarboxylic acids comprise diethylenetriaminotetraacetic acid and ditethylenetriaminotriacetic acid.

16. The aqueous solution according to claim 9, wherein said partially protonated aminopolycarboxylic acid is EDTA and has a stoicheometry of EDTANa_{2±0.5}H_{2±0.5}.

17. Use of a solution according to claim 9, in agriculture uses, cleaning formulations, cosmetic and toiletry uses, food applications, metalworking uses, oil field uses, pharmaceutical uses, photography applications, polymerization, pulp and paper uses, scale removal and prevention, soap uses, textile uses and/or water hardness uses.

18. The aqueous solution according to claim 11, wherein the partially protonated aminopolycarboxylic acid is DTPAFe(III)NaH.

19. The aqueous solution according to claim 18, wherein the iron content is at least is 3 wt % and wherein 70 to 98 wt % of the content of iron in the solution is chelated as DTPAFe(III)NaH.

20. Use of a solution according to claim 19, in agriculture, horticulture uses or photography applications.

21. The use according to claim 20, wherein the solution is used as a fertilizer.
